(19) United States
(12) Patent Application Publication
(10) Pub. No.: US 2021/0142470 A1
(43) Pub. Date: May 13, 2021

(54) SYSTEM AND METHOD FOR IDENTIFICATION OF PULMONARY ARTERIES AND VEINS DEPICTED ON CHEST CT SCANS

(71) Applicant: Xin Meng, Sewickley, PA (US)

(72) Inventor: Xin Meng, Sewickley, PA (US)

(73) Assignee: International Intelligent Informatics Solution Laboratory LLC, Sewickley, PA (US)

(21) Appl. No.: 16/680,632

(22) Filed: Nov. 12, 2019

(51) Int. Cl. G06T 7/00; G06N 20/00

(52) U.S. Cl. CPC G06T 7/0012; G06N 20/00; G06T 2207/10081; G06T 2207/20112; G06T 2207/30101; G06T 2207/20084; G06T 2207/20081; G06T 2207/30061

(57) ABSTRACT

System and methods for identifying pulmonary arteries and veins and creating three-dimensional models of pulmonary arteries and veins. This invention helps lung surgical planning and quantitative analyses of the vessel relevant diseases and the study of vascular alternations, which may serve as biomarkers for other diseases (e.g., COPD or pulmonary hypertension) and their progressions.

### STATEMENT REGARDING FEDERALLY SPONSORED RESEARCH

This invention was created with government support under R44CA203058, awarded by the National Institutes of Health.

### FIELD OF THE INVENTION

The present invention relates to methods and systems for the digital image processing of radiological images, and more particularly, to methods and systems for automatic identification of pulmonary arteries and veins in chest computed tomography (CT) scan images. Embodiments of the present invention are useful in a variety of applications, including, for example, Chronic Obstructive Pulmonary Disease (COPD), pulmonary hypertension, and lung surgical planning.

### BACKGROUND OF THE INVENTION

Pulmonary veins and arteries are responsible respectively for transporting the oxygenated blood to the heart from the lungs and vice versa. There are many diseases or conditions associated with pulmonary veins or pulmonary arteries (e.g., such as pulmonary embolism (PE), pulmonary (arterial/venous) hypertension, and hypoxia). Identifying and differentiating pulmonary arteries and veins are very helpful for quantitative analyses of the relevant diseases and the study of vascular alternations, which may serve as biomarkers for other diseases (e.g., COPD or pulmonary hypertension) and their progressions. In particular, due to their unique roles in the lungs and anatomical characteristics, differentiating pulmonary arteries and veins is often a required procedure to facilitate surgical planning for tumor resection and prevent possible complications. In clinical practice, CT is the most widely used imaging modality for visualization, diagnosis, and treatment of a variety of lung diseases. However, identifying the pulmonary vessels, especially differentiating the arteries and the veins depicted on CT scans is a very challenging task, because they typically have similar densities and are often intertwined with each other in space. The utilization of iodinated contrast agents may lead to somewhat improvement of the contrast between arteries and veins in local regions. But it is still impossible to differentiate them entirely because there is no way to synchronize the dynamic flow of the contrast agent in the lung blood vessels and the optimal time window for CT acquisition. Radiologists identify nodules as benign or malignant primarily based on their image features, such as solidness, calcification, spiculation, and growth rate. However, as an essential feature associated with a tumor, vessel patterns have not been well explored from the imaging perspective, although it plays a very critical role in tumor growth and metastasis.

Due to the challenges mentioned above, there are some but limited investigative efforts dedicated to developing an automated procedure to identify pulmonary arteries and veins. Most of the available approaches took advantage of the lung anatomical knowledge, specifically the proximity of arteries and airways, along with other geometric or image analyses to separate the arteries from the veins. The employed geometric or image analyses include Voronoi diagram, tubular filter, graph-cut, and distance transform. Because it is not easy to reliably quantify the proximity of arteries and airways, which is not always reliable, many of the developed algorithms have limited performance in practice, and additional manual interaction or refinement procedures are often required. Also, the available approaches focused on the separation of lung arteries and veins in the lungs and ignored their relatively large correspondences (i.e., main pulmonary artery and veins) outside of the lungs. The primary reason may be the extremely low contrast between the pulmonary vessels outside the lungs and the background. For the analyses of specific diseases (e.g., PE), it is typically a “must” to identify the main pulmonary artery and vein, where severe obstructions often occur. Also, with the availability of main arteries and veins, it is relatively straightforward and easy to follow the vessels and verify the accuracy of the labeling of arteries and veins.

In the past years, deep learning technology, also known as deep convolutional neural networks (CNNs), has been emerging as a new solution for many challenging image analysis problems and demonstrated promising performance in segmenting a large variety of structures depicted on two- or three-dimensional (2-D/3-D) images. However, the deep learning required a relatively large dataset with labeled information for machine learning purposes. Given the vast number of vessels in the lungs and in particular the similar appearance of (often intertwined) arteries and veins on CT images, it is incredibly challenging and time-consuming to manually and accurately label the vessels. This may be the primary reason that limited the progress made in this regard to date despite so many successful applications of the deep learning technology to the segmentation of various biological structures.

### BRIEF SUMMARY OF THE INVENTION

An object of the present invention is to provide a method, system, and computer program product for the automated identification of pulmonary arteries and veins depicted on CT scans by minimizing the efforts on manual correction to the least, furthermore, to aid in quantitative analyses of the relevant diseases and the study of vascular alternations.

In accordance with one aspect of the disclosure, a computer-implemented method is provided for automatically differentiating pulmonary arteries from veins. The method comprises four steps, identification of the main pulmonary artery and vein, identification of intrapulmonary vessels, skeletonization of intrapulmonary vessels, and differentiation of the intrapulmonary vessels into arteries and veins.

Another aspect is a method for identifying the main pulmonary artery and vein. Firstly, lung volumes are segmented and normalized via an isotropic operation. Furthermore, cubic sub-volumes from the CT scans are cropped and used as inputs for training a deep learning architecture. The outputs are labeled main pulmonary artery and vein, and the false positive detections as well. Lastly, the false positive detections are removed by a post-processing step.

Another aspect of the disclosure addresses a method of data augmentation for enhancing the size and quality of training datasets for deep learning. For better reliability of the trained model, two types of data augmentation are performed, namely geometric augmentation and intensity augmentation in a slice-by-slice manner.

A further aspect is a method for differentiating pulmonary arteries and veins in the lungs after the segmentation of the intrapulmonary vessels. Firstly, the labeled main pulmonary artery and vein are merged with the segmented intrapulmonary vessels. Then the main pulmonary artery/vein is used as the seed to progressively trace the arteries/veins in the lungs along the segmented intrapulmonary vessels with the flooding or region-growing operation. The skeletons of the vessels are extracted, and the distance fields of the merged vessels are computed for the determination along which branch the tracing of the arteries/veins would be continued.

A further aspect of the disclosure addresses that the system includes a graphical user interface, a processor, and software operable on the processor for analyzing the CT scans to identify the pulmonary arteries and veins and displaying a three-dimensional model of the pulmonary arteries and veins on the display.

### BRIEF DESCRIPTION OF THE DRAWINGS

Objects and features of the presently disclosed system and methods would become apparent from the following detailed description of the invention when read with reference to the accompanying drawings, of which:

FIG. 1 is a schematic diagram illustrating a medical imaging system for which embodiments of the present invention are applicable;

FIG. 2 is an example data illustrating pulmonary arteries, veins, and their identifications.

FIG. 3 is an example method for identifying the pulmonary arteries and veins depicted on volumetric CT scans, in accordance with embodiments of the present disclosure;

FIG. 4 is a flowchart illustrating an example method of segmenting the main artery and vein.

FIG. 5 is an example illustrating the identification of the main pulmonary artery and vein depicted on CT scans, in accordance with embodiments of the present disclosure;

FIG. 6 is artificial examples illustrating where the differentiation of arteries and veins may fail.

FIG. 7 is an example illustrating the performance of the skeletonization.

### DETAILED DESCRIPTION

FIG. 1 illustrates a medical imaging system 10 that enables a streamlined workflow for the review and analysis of acquired data from imaging devices, which could facilitate accurate and reliable identification and simulation of anatomical structures. System 10 comprises a computer-aided-detection (CAD) server 20, a web server 30, and a database 40 in accordance with an embodiment of the present invention. Image data 50 of an anatomic region of interest, such as a chest (not shown), are imported or sent from an imaging device 60 to the system 10 via network 70. An imaging device is, for example, a CT scanner, picture archive and communication system (PACS), or a film digitizer. The image data sent to the system is stored in a database 40. A web server is responsible for classifying the image data saved in the database and assigning the data to a CAD server 20 unit for processing. The processing results then return to the web server 30 and are viewed via an interface unit 80. It should be understood that the system 10 and its method of operation may be used in numerous other digital image processing applications.

FIG. 2 illustrates the arteries, veins, and their segmentations using an example. FIG. 2A is a local region of a chest CT scan. The labels of the arteries, veins, and airways, as well as their spatial relationship depicted on CT images (shown in FIG. 2B). FIG. 2C displays the intrapulmonary vessels without the differentiation of the arteries and veins, and FIG. 2D displays the identification of arteries and veins, including the main pulmonary artery and vein.

FIG. 3 illustrates an example method to differentiate arteries from veins. The processing starts after the CAD server 20 (shown in FIG. 1) is assigned with image data for processing. It comprises four steps, the identification of the main artery and vein 220, the identification of the intrapulmonary vessels 230, the skeletonization of the intrapulmonary vessels 240, which are used to aid in the tracing of neighboring vessel branches. After performing these procedures, the intrapulmonary vessels are tracked progressively under the help of the main artery/vein and the skeletons of the intrapulmonary vessels to differentiate the intrapulmonary vessels into arteries and veins (250).

In step 220, in accordance with some embodiments, a novel combination of deep learning techniques can be effectively used to identify the main pulmonary artery and vein in volumetric images, such as medical CT and MRI scans. The implementation at step 220 involves the following procedures or steps, shown in FIG. 4. In step 221, Lung volume segmentation: The segmentation of the lung volumes is to limit the computation and training within the lung region and thus minimize the computational cost. The embodiment of the lung segmentation method may be based on [Pu et al. Adaptive border marching algorithm: automatic lung segmentation on chest CT images. Comput Med Imaging Graph. 2008 September; 32(6):452-62.]. In step 223, to alleviate the impact of the image resolutions on machine learning, the chest CT scans are normalized via an isotropic operation, by which the image resolutions along the three orthogonal directions are set at the same value (e.g., 1 mm). In step 225, a number of cubic sub-volumes (e.g., 96×96×96 mm³) from the CT scans are randomly cropped and are used to train a deep learning architecture. In the embodiment of sampling of 3D image patches, any suitable technique can be used to generate sub-volumes from the CT scans. The cubic sampling strategy applied in the present invention is to assure that every sampling operation generates two cubic sub-volumes, one is centered on the foreground (i.e., the center is located on the vessels), and the other is centered on the background (i.e., the center is located on the non-vessels). In step 227, any suitable deep learning architectures can be used for the training. The present invention uses the classical U-Net model as an example to illustrate the segmentation of the main pulmonary artery and vein. The 3-D U-Net architecture is formed by two paths, namely the encoding (or down-sampling) path, and the decoding (or up-sampling) path. In the embodiment of the present invention, both paths have four convolutional layers, and each layer is formed by two 3×3×3 convolutions and a 2×2×2 maximum pooling. For better reliability of the trained model, two types of data augmentation are performed, namely geometric augmentation and intensity augmentation in a slice-by-slice manner. The geometric augmentation, including rotation [−90, 90], vertical/horizontal flipping, and scaling [0.9, 1.1], was applied to both the images and the labeled masks. The intensity augmentation, including intensity shift with a range of [−25, 25] Hounsfield unit (HU) and image blurring, were applied only to the images. It is always unavoidable to have some false positive detections when applying the trained model to a chest CT scan. In step 231, some embodiments are used to remove the false positive detections after the application of the trained model to the CT scans. Only the first two largest detected regions are kept, whereas all other detections are removed.

The example in FIG. 5 illustrates the segmentation result when applying the trained model to a chest CT scan. In FIG. 5A and FIG. 5C were the original CT images, FIG. 5B and FIG. 5D showed the identified main pulmonary artery and vein (as outlined by different colors) by the computer algorithm, FIG. 5E showed the reconstructed 3-D model of the local region near the hilum (as indicated by the box in (FIG. 5C) without the application of the developed computer algorithm, where the arrows indicated the fusion of the arteries and lungs, and FIG. 5F shows the 3-D model of the identified main pulmonary artery and vein after the removal of the false-positive detection regions.

The next step, 230, is to segment intrapulmonary vessels. The embodiment of the present invention uses a computational geometric solution [Pu et al. A differential geometric approach to automated segmentation of human airway tree. IEEE Trans Med Imaging. 2011 February; 30(2):266-78.] as an example to illustrate the identification of the pulmonary vessels. The unique characteristic of this approach in methodology is the utilization of both principal curvatures and the principal directions along with a “puzzle-game” procedure to identify the tubular-like regions. Although this approach is initially developed for the airway tree segmentation, it can be applied to identify lung vessels as well because the only difference between airways and vessels is the sign of the curvatures. The vessels have high densities and appear as convex tubular structures, which have a positive sign in curvature. The airways have low densities and appear as concave tubular structures, which have a negative sign in curvatures. Therefore, simply changing the sign of the curvatures will lead to the identification of either airways (negative curvatures) or vessels (positive curvatures).

The fourth step, 240, is the differentiation of arteries and veins in the lungs. In order to differentiate the intrapulmonary vessels into arteries and veins, the main pulmonary artery and vein are used as the seeds to trace the arteries and veins in the lungs progressively. The embodiment of the differentiation procedure consists of the following steps: (1) Merge the main pulmonary artery and vein with the intrapulmonary vessels. In most cases, the main artery/vein can be completely fused with the vessels in the lungs. However, there are always some cases whether there are gaps between some branches of the intrapulmonary vessels near the hilum and the main arteries/veins, which will cause the interruption of the tracing operation. Hence, the embodiment of the present invention uses the dilated operation to bridge these gaps by only including the regions with high densities in the lungs. (2) Trace the arteries and veins. In anatomy, the lung arteries and veins should be separated in space. Given a seed on either arteries or veins, a simple flooding or region-growing operation is able to identify the arteries and veins. However, due to the fact that the lung arteries and veins are often intertwined and could be very close in some parts of the lungs, the image partial effects often make them fused with each other (as the arrow indicated in FIG. 5E), thereby leading to incorrect labeling. In addition, the presence of diseases or other image artifacts may disconnect the vessels and thus stop the region growing procedure for some vessel branches (e.g., the disconnections in FIG. 6A and FIG. 6B). The disconnection will stop the region growing operation, and the fusion will lead to incorrect labeling.

In some embodiments, the skeletons and the distance fields of the merged vessels are computed for the correct tracing of the arteries/veins. The algorithm (Cornea et al. Curve-skeleton properties, applications, and algorithms. IEEE Transactions on Visualization and Computer Graphics. 2007 May; 13(3):530-548.) is used as an example to extract the skeletons of the vessels automatically. This algorithm reconstructed a “repulsive force field” to characterize the centerline of an object. The unique strength of this skeletonization algorithm is the ability to extract the skeleton of an arbitrary object at a specified level of detail and to concurrently detect the critical points (corresponding to the endpoints of the vessel branch).

The vessels are represented as a number of individual branches via the skeletonization (FIG. 6C), on the basis of which we computed the orientation of each branch based on its two endpoints. The distance field of the vessels is then calculated using the fast transformation method for obtaining the distance of a point on the skeletons to the vessel boundaries. The averaged distance values of the skeleton points on each branch are used to denote the size (i.e., the average radius of the cross-section) of the branch. With the consideration that the dimensions of the pulmonary vessels decrease progressively while branching towards the lung boundaries, the same but disconnected branches should have similar orientation and size, such as branch 1 and branch 2 in FIG. 7A, branch 4 and branch 5 in FIG. 7B. Hence, the tracing of the artery/vein would be continued along the determined branch by assessing the orientation and the size of the neighboring branches, as shown in FIG. 7.

We claim:

1. A computer-implemented method for automatically differentiating pulmonary arteries from veins, comprising the steps of:
a) Identifying the main pulmonary artery and vein;
b) Identifying intrapulmonary vessels;
c) Extracting the skeletonization of intrapulmonary vessels;
d) Differentiating intrapulmonary vessels into arteries and veins.

2. The method of claim 1, wherein the identification of the main pulmonary artery and vein further comprising:
a) Segmenting lung volumes from the CT scans to limit the computation and training within the lung region and thus to minimize the computational cost;
b) Normalizing the CT scans;
c) A sampling of 3D image patches by cropping the cubic sub-volumes from the CT scans as the inputs for training a deep learning architecture;
d) Training a convolutional neural network (CNN);
e) Removing the false positive detections of the main pulmonary artery and vein.

3. The method of claim 2, wherein normalizing the CT scans comprising:
An isotropic operation, by which the image resolutions along the three orthogonal directions are set at the same value.

4. The method of claim 2, wherein sampling 3D image patches comprising:
Cropping the cubic sub-volumes randomly from the segmented lung regions. Every sampling operation generates two cubic sub-volumes, one is centered on the foreground (i.e., the center is located on the vessels), and the other one is centered on the background (i.e., the center is located on the non-vessels).

5. The method of claim 2, wherein the training of a CNN comprising:
a) Training a 3-D CNN using a training set of the cropped cubic sub-volumes and the data augmentation;
b) The encoding (or down-sampling) path and the decoding (or up-sampling) path, each of which has four convolutional layers, and each layer is formed by multiple convolutions and a maximum pooling;
c) A dropout layer at the end of each layer.

6. The method of claim 5, wherein the data augmentation comprising:
a) Two types of data augmentation for enhancing the size and quality of training datasets for deep learning, namely geometric augmentation and intensity augmentation in a slice-by-slice manner;
b) The geometric augmentation, including rotation, vertical/horizontal flipping, and scaling, is applied to both the images and the labeled masks;
c) The intensity augmentation, including intensity shift and image blurring, is applied to only the images.

7. The method of claim 2, wherein removing the false positive detections of the main pulmonary artery and vein, further comprising a strategy that only the first two largest detected regions are kept, whereas all other detections are removed. These the largest two regions are the main pulmonary artery and vein.

8. The method of claim 1, wherein segmenting intrapulmonary vessels further comprising:
a) Utilizing the geometric feature of vessels, which have high densities and appear as convex tubular structures;
b) A positive sign in the curvatures of tubular vessels.

9. The method of claim 1, wherein the differentiation of arteries and veins in the lungs comprising:
a) Merging the main pulmonary artery and vein with the intrapulmonary vessels;
b) Tracing the arteries and veins along the segmented intrapulmonary vessels.

10. The method of claim 9, wherein merging the main pulmonary artery and vein with the intrapulmonary vessels further comprising:
A method that the dilated operation to bridge the gaps between some branches of the intrapulmonary vessels near the hilum and the main arteries/veins, which may cause the interruption of the tracing operation.

11. The method of claim 9, wherein tracing the arteries and veins in the lungs comprising:
a) The extraction of the skeletons and the computation of the distance fields of the merged vessels;
b) A strategy that determines along which branch the tracing of the arteries/veins will continue is that the neighboring branches having similar orientation and size should both belong to the same type of vessels.

12. The method of claim 11, wherein the computation of the distance fields of the merged vessels further comprising:
a) Representing the vessels as individual branches via the skeletonization;
b) Calculating the orientation of each vessel based on its two endpoints;
c) Computing the distance field of each branch;
d) Calculating the distance of a point on the skeletons to the vessel boundaries;
e) Denoting the size (i.e., the average radius of the cross-section) of each branch
